(19) United States
(12) Patent Application Publication
(10) Pub. No.: US 2025/0032995 A1
(43) Pub. Date: Jan. 30, 2025

(54) Plasmonic Heating Assisted Interfacial Polymerization for Reverse Osmosis Membrane Fabrication

(71) Applicant: The University of Hong Kong, Hong Kong (CN)

(72) Inventors: Chuyang TANG, Hong Kong (CN); Qimao GAN, Hong Kong (CN); Hao Guo, Hong Kong (CN)

(73) Assignee: The University of Hong Kong, Hong Kong (CN)

(21) Appl. No.: 18/770,385

(22) Filed: Jul. 11, 2024

Related U.S. Application Data
(60) Provisional application No. 63/528,550, filed on Jul. 24, 2023.

(51) Int. Cl. B01D 67/00; B01D 61/02; B01D 69/10; B01D 69/14; B01D 71/56

(52) U.S. Cl. CPC B01D 67/00793; B01D 61/025; B01D 67/0006; B01D 69/107; B01D 69/14111; B01D 69/148; B01D 71/56; B01D 2323/34

(57) ABSTRACT

An interfacial plasmonic heating intensified IP reaction (IPH-IP) is used to fabricate highly permeable and selective polyamide RO membranes. Silver nanoparticles (AgNPs) are introduced to the IP reaction interface to serve as nano-heat generators under light illumination. The coupling of generated nano-heat rapidly promotes the interfacial temperature, thereby boosting the formation of extensively “nano-foamed” polyamide with prominent nanovoids and high crosslinking degree. These features enable the resulting RO membrane to achieve a superior combination of water permeance (3.4 L m⁻² h⁻¹ bar⁻¹) and NaCl rejection (99.7%). This outstanding separation performance further enables the membrane to efficiently remove a wide spectrum of toxic contaminants frequently found in different water sources, revealing huge potential for various water treatment applications. In addition, the resulting RO membrane demonstrates efficient desalination of real seawater, producing clean water with high quality that far exceeds those of benchmarking commercial membranes.

### CROSS REFERENCE TO RELATED APPLICATION

The present application claims the benefit of U.S. patent application Ser. No. 63/528,550, filed Jul. 24, 2023, which is hereby incorporated by reference in its entirety.

### FIELD OF THE INVENTION

The present invention relates to a plasmonic heating assisted interfacial polymerization method for the fabrication of high-performance reverse osmosis membranes, and more particularly to the use of a method with fabricated membranes to achieve universally high removal of various water contaminants.

### BACKGROUND OF THE INVENTION

Conventional reverse osmosis (RO) membranes are limited by the permeance-selectivity trade-off and often have inadequate removal of toxic and harmful contaminants, such as boron in seawater, arsenic (III) in groundwater, and endocrine disrupting compounds in wastewater. With four billion people suffering limited access to reliable clean water, water scarcity is becoming a pressing challenge on the global scale [1]-[2]. Reverse osmosis (RO) plays a tremendous role in addressing this challenge by augmenting a daily freshwater supply of ˜21 billion gallons globally through seawater desalination [3]-[4]. In addition, its ability to produce clean water from wastewater, groundwater, and other non-traditional water sources offers great potential to further alleviate water scarcity [5]-[8]. Nevertheless, existing polyamide RO membranes are strongly constrained by the permeance-selectivity trade-off: increasing water permeance often results in decreased water-salt selectivity and vice versa [9]-[11]. Meanwhile, their inadequate removal of toxic and harmful contaminants, such as boron in seawater [10], [12]-[14], arsenic (As (III)) in groundwater [15]-[17], and endocrine disrupting compounds (EDCs) in wastewater [18]-[20], poses severe threats to the safety of water produced by this method. These limitations necessitate the exploitation of high-performance RO membranes applied to various water treatment scenarios for efficient clean water production.

The separation performance of a polyamide RO membrane is greatly dependent on the properties of its polyamide layer [21]-[22]. This layer is typically prepared through interfacial polymerization (IP) reactions on a porous substrate. In particular, amine monomers diffuse from an aqueous solution into an organic solution to react with acyl chlorides at the aqueous/organic interface. In principle, an IP reaction generates heat that can facilitate the interfacial degassing/vaporization, thereby resulting in the formation of a nanovoids-containing polyamide structure, as shown in FIG. 1A [23]-[27]. This “nano-foamed” structure is believed to be highly correlated with membrane water permeance [23], [27]-[30]. Meanwhile, the generated reaction heat affects the diffusivity and reactivity of monomers, which significantly influence the crosslinking of polyamide and thus membrane selectivity [11], [31], [32]. It is postulated that well-controlled local heating at the interface can intensify the IP reaction for breaking the permeance-selectivity trade-off and achieving broad-spectrum removal of contaminants. To accomplish this purpose, a plasmon-induced local photothermal effect shows tremendous promise.

Specifically, owing to the strong plasmon resonances of metallic nanoparticles (e.g., silver) under visible or infrared light illumination, solar energy can be efficiently converted into heat at the surfaces of those nanoparticles [33]-[36]. This plasmonic photothermal phenomenon has been widely utilized to produce local heating in solar steam generation [37], photocatalysis [38], cancer therapy [39], molecular delivery [40], and other photothermal related applications [33]-[36].

### SUMMARY OF THE INVENTION

The present invention is an improvement in the existing interfacial polymerization process for reverse osmosis (RO) membrane fabrication. Compared with the existing method, this invention integrates plasmon-induced photothermal heat conversion into the IP process to achieve in-situ interfacial plasmonic heating to intensify the interfacial polymerization process, thereby tailoring the polyamide layer so as to significantly improving the formation of RO membranes, enabling the fabricated RO membranes to achieve remarkable separation performance.

In carrying out the present invention, which relates to an interfacial plasmonic heating intensified IP reaction (IPH-IP) to fabricate highly permeable and selective polyamide RO membranes, silver nanoparticles (AgNPs) are introduced to the IP reaction interface to serve as nano-heat-generators under light illumination, as shown in FIG. 1B. The coupling of generated nano heat rapidly promotes the interfacial temperature, thereby boosting the formation of extensively “nano-foamed” polyamide with prominent nanovoids and a high crosslinking degree. These features enable the resulting RO membrane to achieve a superior combination of water permeance (3.4 L m⁻² h⁻¹ bar⁻¹) and NaCl rejection (99.7%), which breaks the permeance-selectivity trade-off to a great extent. This outstanding separation performance further allows the membrane to efficiently remove a wide spectrum of toxic contaminants frequently found in different water sources, revealing a huge potential for various water treatment applications. In addition, the RO membrane demonstrates efficient desalination of real seawater, producing clean water with high quality that far exceeds those of benchmarking commercial membranes.

Restated, according to the present invention, silver nanoparticle induced interfacial plasmonic heating can intensify the interfacial polymerization reaction for extensive fabrication of “nano-foamed” polyamide with prominent nanovoids and high crosslinking degree. These features enable the resulting reverse osmosis membrane to achieve simultaneously high water permeance and the rejection of salts and various toxic contaminants in water. The present invention is the first instance of silver nanoparticle induced interfacial plasmonic heating integration to intensify the interfacial polymerization reaction for fabricating highly permeable and selective polyamide reverse osmosis membranes towards versatile water purification.

Prior literature used silver nanoparticles as the interlayer confined between the substrate and polyamide layer [42]. The water layer around each hydrophilic nanoparticle could induce the hydrolysis of trimesoyl chloride monomers and thus the termination of interfacial polymerization. This effect can create nanochannels of approximately 2.5 nm in size around the AgNPs, contributing to the improvement of membrane water permeance. However, according to the present invention, the interfacial plasmonic heating effect is utilized and induced by AgNPs under light illumination during the interfacial polymerization, which can tailor the membrane separation performance. This interfacial plasmonic heating effect has not previously been reported for preparing polyamide reverse osmosis membranes.

Additional prior literature presented a facile procedure for loading AgNPs on a thin-film composite reverse osmosis membrane surface as a coating [41]. This AgNPs coating was used to suppress biofilm formation on the membrane surface, contributing to an enhanced biofouling property. The formation of AgNPs on the membrane surface resulted in decreased membrane water permeance; however, the present invention leads to significant increases in the water permeance.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

The foregoing and other objects and advantages of the present invention will become more apparent when considered in connection with the following detailed description and appended drawings in which like designations denote like elements in the various views, and wherein:

FIG. 1A is a schematic depiction of the conventional interfacial polymerization (IP) process, wherein an IP reaction generates heat that can facilitate interfacial degassing/vaporization, thereby resulting in the formation of a nanovoids-contained polyamide structure, and FIG. 1B is a schematic depiction of the IPH-IP process of the present invention, wherein silver nanoparticles (AgNPs) are introduced to the IP reaction interface to serve as nano-heat generators under light illumination;

FIG. 2 depicts the XRD patterns of a PSf substrate and an AgNPs-modified PSf substrate;

FIGS. 3A-3D depict modified PSf substrates with different AgNPs loading (FIG. 3A is labelled “substrate,” FIG. 3B is labelled “Sub-Ag50,” FIG. 3C is labelled “Sub-Ag200,” and FIG. 3D is labelled “Sub-Ag400”);

FIG. 4 is the UV-VIS-NIR absorption spectra corresponding to each of the four substrates in FIGS. 3A-3D;

FIGS. 5A-5D are infrared thermal images under solar light corresponding to the four substrates in FIGS. 3A-3D;

FIGS. 6A-6D depict micrographs of the membrane cross-sections in the context of the properties of polyamide membranes from IPH-IP with 0, 50, 200, and 400 mM AgNO₃ solution, and FIGS. 6E-6H depict SEM micrographs of the membrane top surfaces in the context of the properties of polyamide membranes from IPH-IP with 0, 50, 200, and 400 mM AgNO₃ solution;

FIG. 7A is a bar graph of void fractions within the polyamide layers measured using TEM, FIG. 7B is a bar graph of cross-linking degrees of the polyamide layers, FIG. 7C is a plot of Zeta potentials of the membranes, FIG. 7D is a bar graph of membrane separation performance with different AgNPs loading (i.e., using PSf substrate, Sub-Ag50, Sub-Ag200, and Sub-Ag400) under a light intensity of 1 kW/m², FIG. 7E is a bar graph of membrane separation performance with same AgNPs loading (i.e., using Sub-Ag200) under different light intensities (kW/m²), and FIG. 7F is a plot of separation performance in terms of water permeance and water/NaCl selectivity of the results of the present invention (red stars) as compared with prior literature data (black circles);

FIGS. 8A-8D depict TEM micrographs of the membrane cross-sections in the context of properties of polyamide membranes with and without AgNPs and with and without light and FIGS. 8E-8H depict SEM micrographs of the membrane top surfaces in the context of properties of polyamide membranes with and without AgNPs and with and without light;

FIG. 9 is a bar graph of the separation performance of polyamide membranes with and without AgNPs and with and without light;

FIGS. 10A-10D depict TEM micrographs of the membrane cross-sections in the context of properties of polyamide membranes under different light wavelengths and FIGS. 10E-10H depict SEM micrographs of the membrane top surface properties of polyamide membranes under different light wavelengths;

FIG. 11 is a bar graph that depicts the separation performance of polyamide membranes under different light wavelengths;

FIGS. 12A-12D depict TEM micrographs of the membrane cross-sections in the context of properties of polyamide membranes under different light intensities (kW/m²) and FIGS. 12E-12H depict different SEM micrographs of the membrane top surfaces in the context of properties of polyamide membranes under different light intensities (kW/m²);

FIG. 13 is a bar graph that depicts the separation performance of polyamide membranes prepared by different plasmonic nanomaterials (i.e., Cu and Ag);

FIG. 14 correspond to bar graphs of real seawater concentrations of Na⁺, K⁺, Cl⁻, and SO₄²⁻, and their rejections by the membranes;

FIGS. 15A-15C correspond to 3D-fluorescence spectra of the dissolved organics in real seawater and permeates of the membranes;

FIG. 16A is a bar graph of rejection of B (5 ppm, pH of ˜8.5 for seawater) and As (III) (5 ppm, pH of ˜8.5 for groundwater), FIG. 16B is a plot of rejection of N (15 ppm, pH of ˜7.5 for wastewater) and P (1 ppm, pH of ˜7.5 for wastewater), and FIG. 16C is a plot of rejection of various EDCs (200 ppb, pH of ˜7.5 for wastewater); and

FIG. 17 is a plot of the rejection of 17 harmful contaminants frequently found in different water sources (e.g., boron in seawater, As (III) in groundwater, N, P, EDCs, antibiotics, and PFASs in wastewater) and rejection of 6 typical ions by the TFC-Ag200L. Error bars represent standard deviations using three distinct samples.

### DETAILED DESCRIPTION OF THE INVENTION

In carrying out the method of the present invention various chemicals are utilized. In particular, m-phenylenediamine (MPD), trimesoyl chloride (TMC), and n-hexane obtained from Sigma-Aldrich are applied to prepare polyamide layers on polysulfone (PSf) substrates (MWCO 67 kDa, Vontron Technology) through interfacial polymerization (IP) reactions. Inorganic compounds of silver nitrate (AgNO₃, Sigma-Aldrich) and sodium borohydride (NaBH₄, Dieckmann) are used to generate AgNPs in situ on the substrates. Sodium chloride (NaCl, Dieckmann) is used for separation performance tests. Boric acid (B (OH) 3, Dieckmann) and arsenic (III) oxide (As203, Dieckmann) are used as model contaminants in seawater and groundwater, respectively. Sodium dihydrogen phosphate (NaH₂PO₄, Dieckmann) and ammonium chloride (NH₄Cl, Dieckmann) are used as inorganic model contaminants in wastewater. Endocrine disrupting compounds (EDCs, including methylparaben (MP), ethylparaben (EP), propylparaben (PP), and benzylparaben (BP)), obtained from Sigma-Aldrich, are used as organic model contaminants in wastewater.

The preparation of conventional polyamide RO membranes is as follows: First, a 2 w/w % MPD solution is applied to immerse a PSf substrate for 2 minutes. After removing the excess MPD solution by a rubber roller, the substrate is soaked in a 0.1 w/w % TMC/hexane solution for 1 minute to form the polyamide layer. The prepared polyamide RO membrane is named TFC.

The preparation of IPH-IP intensified polyamide RO membranes of the present invention is as follows. To start, the AgNPs are generated in situ on the PSf substrate according to published literature [41]-[42]. Briefly, an AgNO₃ solution (50, 200, or 400 mM) is applied to soak a PSf substrate with shaking for 10 minutes at 50 rpm. The extra AgNO₃ solution is removed by a rubber roller. Then, a NaBH₄ solution (200 mM) is poured onto the PSf substrate to reduce silver ions (Ag) to AgNPs with shaking for 10 minutes at 50 rpm. The substrate is subsequently rinsed with deionized (DI) water for 5 minutes. The AgNPs-modified substrates are named as sub-Ag50, sub-Ag200, and sub-Ag400, respectively, depending on the amount of Ag contained therein. For the final step, the AgNPs-modified substrate is used to prepare the polyamide layer through IP reaction under simulated solar light illumination of 1 kW/m² (a xenon lamp, CEL-S500, obtained from Beijing Jin Yuan Science and Technology Co., China) with an Air Mass 1.5 filter. The prepared polyamide RO membranes are named as TFC-Ag AgNO₃ concentration L, e.g., TFC-Ag200L, indicating preparation using 200 mM AgNO₃ under solar light illumination. To further investigate the effects of light illumination, polyamide RO membranes are prepared under different light wavelengths (using two band-pass filters for light wavelengths of ˜400 and ˜600 nm, respectively) and intensities (0.5 kW/m², 2 kW/m², and 4 kW/m²). These membranes are named TFC-Ag200L-400 nm, TFC-Ag200L-600 nm, TFC-Ag200L-0.5, TFC-Ag200L-2, and TFC-Ag200L-4, respectively.

The membranes can then be characterized. The PSf substrate with and without AgNPs and the polyamide membrane surface were characterized by field-emission scanning electron microscopy (FE-SEM, S-4800, Hitachi) at an accelerating voltage of 5 kV. All SEM samples were dried at 40° C. in an oven, and then sputter coated by gold for 40 seconds before characterization. The formation of AgNPs on the substrates were characterized by X-ray diffraction (XRD) patterns recorded by Rigaku Ultima IV. The light absorption spectra (300 nm to 2500 nm) of the substrates were measured using a UV-VIS-NIR spectroscopy (UV-3600i Plus, Shimadzu) equipped with an integrating sphere. Their corresponding infrared thermal images were recorded by an infrared camera (Fluke, TiX580).

The membrane cross-section was observed using transmission electron microscopy (TEM, CM100, Philips) at an accelerating voltage of 100 kV. All membrane samples were immersed in 10 v/v % glycerol/water for 1 hour and dried at 40° C. in an oven before TEM characterization [26]-[27], [43-45]. The membrane surface charge property was measured by a streaming potential analyzer (SurPASS, Anton Paar). The elemental composition of the membrane surface was analyzed by X-ray photoelectron spectroscopy (XPS, Thermo Scientific K-Alpha).

Next the membrane separation performance was tested. The separation performance was tested using a laboratory-scale crossflow RO filtration system. A membrane sample with a filtration area of 12 cm² was applied in a stainless-steel cell. After being pre-compacted at 17.0 bar using 2,000 ppm NaCl feed solution for 3 hours at a crossflow velocity of 22.4 cm/s under room temperature (˜25° C.), the permeate samples were collected for measuring the water flux and salt rejection. The water flux Jᵥ (L m⁻² h⁻¹) and water permeance A (L m⁻² h⁻¹ bar⁻¹) were calculated using the following expressions:

$${J}_{v} = \frac{Δ m}{Δ t \times a \times ρ} \qquad ( 1 )$$

$$A = \frac{{J}_{v}}{Δ P - Δ π} \qquad ( 2 )$$

where Δm (kg) is the mass of permeate over a time interval of At (hours), a (m²) is the membrane filtration area, ρ (kg/m³) is the density of water, ΔP (bar) is the applied pressure, and Art (bar) is the transmembrane osmotic pressure.

The NaCl rejection (R) and permeability coefficient (B) were calculated using the following expressions [10]-[11]:

$$R = \frac{{C}_{f} - {C}_{p}}{{C}_{f}} \times 100 \% \qquad ( 3 )$$

$$B = ( \frac{1}{R} - 1 ) \times {J}_{v} \times {e}^{\frac{Jw}{K}} \qquad ( 4 )$$

where C_{f} and Cₚ are NaCl concentrations in the feed and the permeate based on conductivity measurements (Ultrameter II, Myron L). The water-NaCl perm-selectivity is represented by the A/B ratio [10]-[11].

To assess the contaminant removal efficiency of the membranes, a feed solution containing 5 ppm B (for seawater, pH at ˜8.5), or 5 ppm As (III) (for groundwater, pH at ˜8.5), or 15 ppm N and 1 ppm P (for wastewater, pH at ˜7.5) or 200 ppb various EDCs were used for filtration testing.

To evaluate the potential for practical applications of the membranes, real seawater obtained from Victoria Harbour (in Hong Kong) was used as the feed solution under a testing pressure of 55 bar.

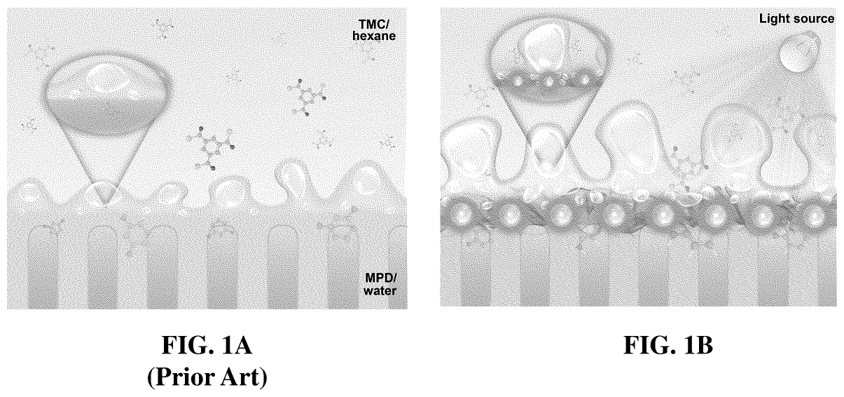

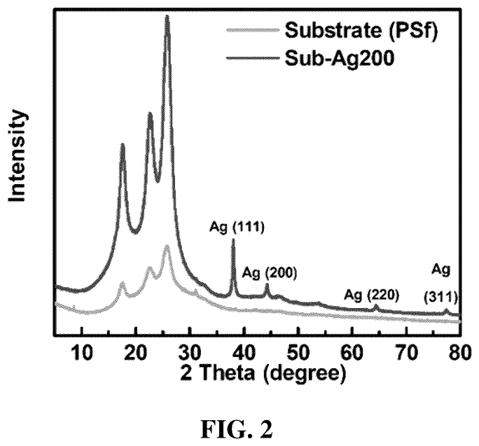

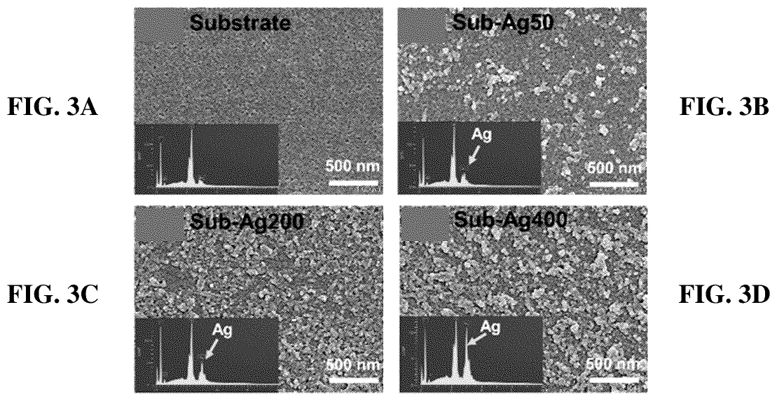

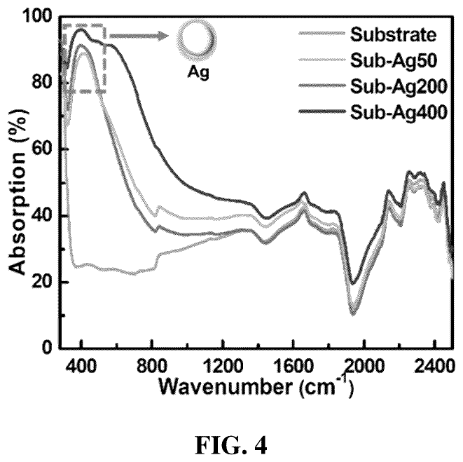

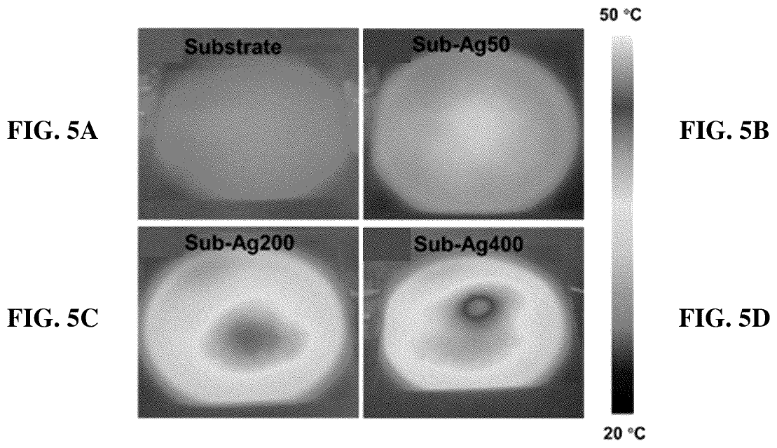

According to the present invention plasmonic heating is created at the nano-interface. FIGS. 1-5 depict schematic diagrams of membrane fabrication and characterizations of plasmonic responses of AgNPs. FIG. 1A is a schematic depiction of the conventional interfacial polymerization (IP) process. FIG. 1B is a schematic depiction of the IPH-IP process, wherein silver nanoparticles (AgNPs) are introduced to the IP reaction interface to serve as nano-heat-generators under light illumination. FIG. 2 depicts the XRD patterns of PSf substrate and AgNPs-modified PSf substrate. FIGS. 3A-3D depict modified PSf substrates with different AgNP loading (FIG. 3A is labelled “substrate,” FIG. 3B is labelled “Sub-Ag50,” FIG. 3C is labelled “Sub-Ag200,” and FIG. 3D is labelled “Sub-Ag400”). FIG. 4 is the UV-VIS-NIR absorption spectra corresponding to each of the four substrates in FIG. 3. FIGS. 5A-5D are infrared thermal images under solar light corresponding to the four substrates in FIG. 3.

To achieve the above interfacial plasmonic heating during the IP reaction, AgNPs were generated in situ on the PSf substrate in advance through reduction of AgNO₃ by NaBH₄. The x-ray diffraction (XRD) pattern of the modified substrate shows characteristic peaks at 38.5°, 44.2°, 64.4°, and 77.4° (FIG. 2), corresponding to the (111), (200), (220), and (311) diffractions of Ag

crystal [46]-[47], proving the formation of Ag on its surface. The other obvious peaks, such as those at 17.6°, 22.6°, and 25.8°, could likely be derived from the PSf substrate since they were observed for both the pristine and modified substrates. Further characterizing the substrate surfaces (modified with different AgNO₃ solution concentrations) using SEM micrographs and EDS analysis could confirm the formation of AgNPs (FIGS. 3A-3D). Increased AgNO₃ solution concentration results in larger coverage or loading of AgNPs on the substrate surfaces. The UV-VIS-NIR absorption spectra of the modified surfaces displays notably higher absorption (above 90%) at a wavelength of ˜400 nm compared to that (below 30%) of the pristine substrate (FIG. 4), which can be attributed to the strong plasmon resonance of AgNPs at this wavelength [48]-[49]. Notably, larger coverage or loading of AgNPs on the substrate surfaces contributed to higher absorption at the wavelength of ˜400 nm, thus leading to increasing surface temperature under solar light illumination (FIGS. 5A-5D).

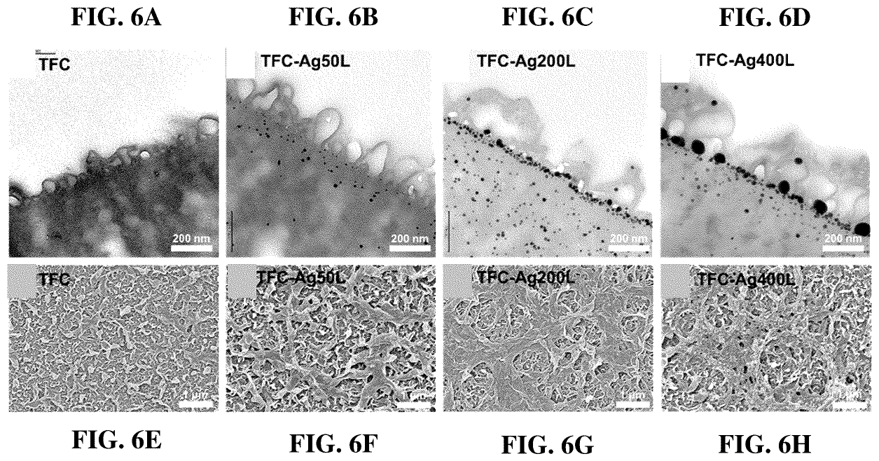

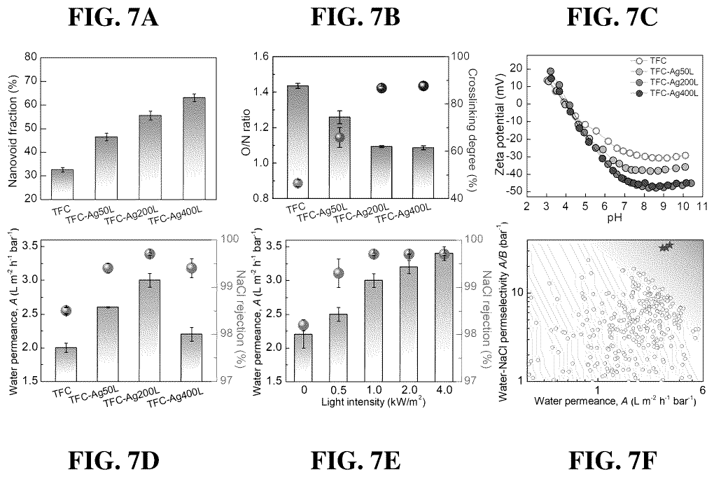

The properties and separation performance of polyamide membranes from IPH-IP can also be studied. FIGS. 6A-6D depict micrographs of the membrane cross-sections. FIGS. 6E-6H depict SEM micrographs of the membrane top surfaces. FIG. 7A is a plot of void fractions within the polyamide layers measured using TEM. FIG. 7B is a plot of cross-linking degrees of the polyamide layers. FIG. 7C is a plot of zeta potentials of the membranes. FIG. 7D is a plot of membrane separation performance with different AgNP loading under a light intensity of 1 kW/m². FIG. 7E is a plot of membrane separation performance with different AgNP loading under different light intensities (kW/m²). FIG. 7F is a plot of separation performance in terms of water permeance and water/NaCl selectivity of the results of the present invention (red stars) as compared with literature data (black circles).

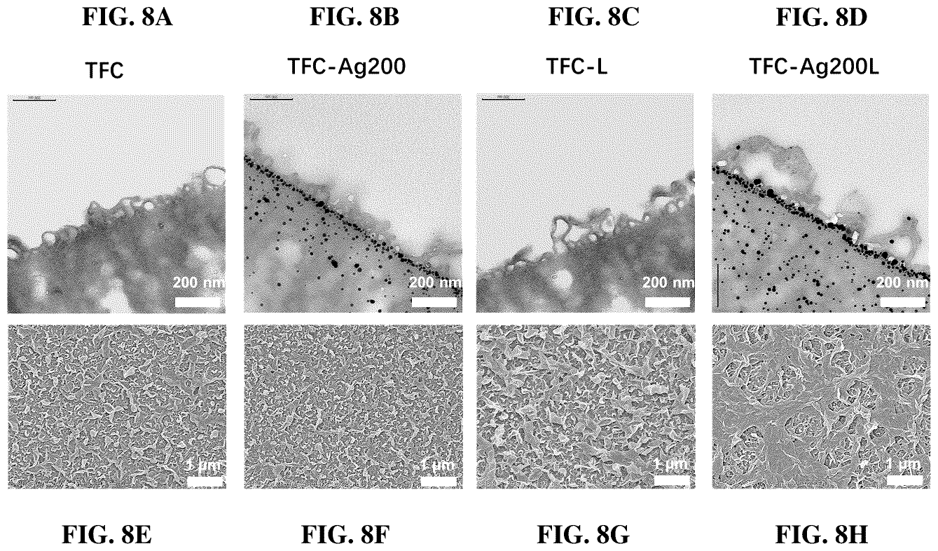

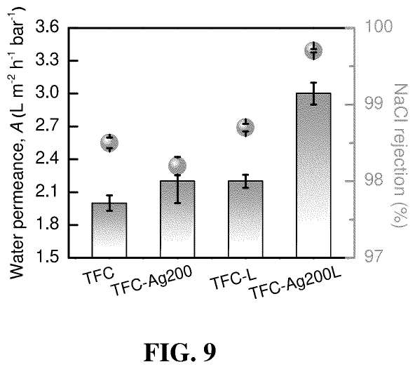

Properties of polyamide membranes with/without AgNPs and with/without light can be shown. FIGS. 8A-8D depict TEM micrographs of the membrane cross-sections. FIGS. 8E-8H depict SEM micrographs of the membrane top surfaces. FIG. 9 is a plot of the separation performance of polyamide membranes with and without AgNPs and with and without light.

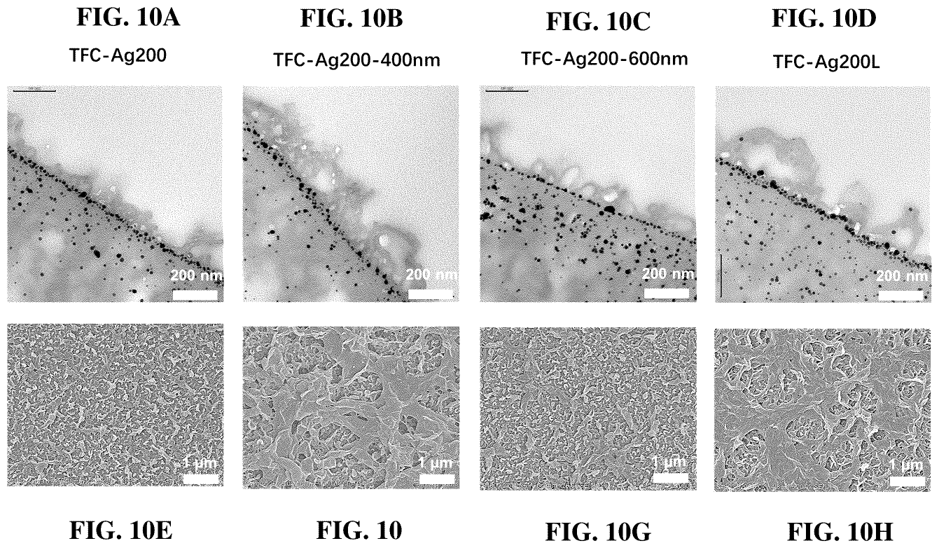

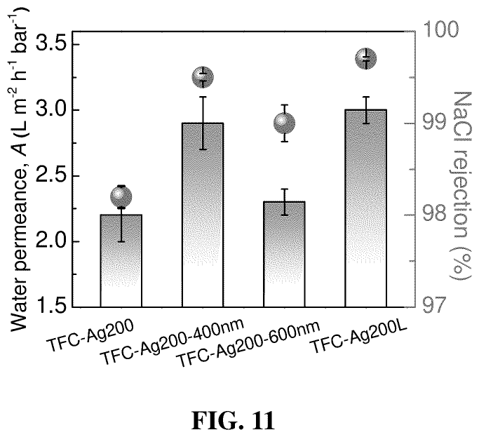

Properties of polyamide membranes under different light wavelengths can further be shown. FIGS. 10A-10D depict TEM micrographs of the membrane cross-sections. FIGS. 10E-10H depict SEM micrographs of the membrane top surfaces. FIG. 11 depicts separation performance of polyamide membranes under different light wavelengths.

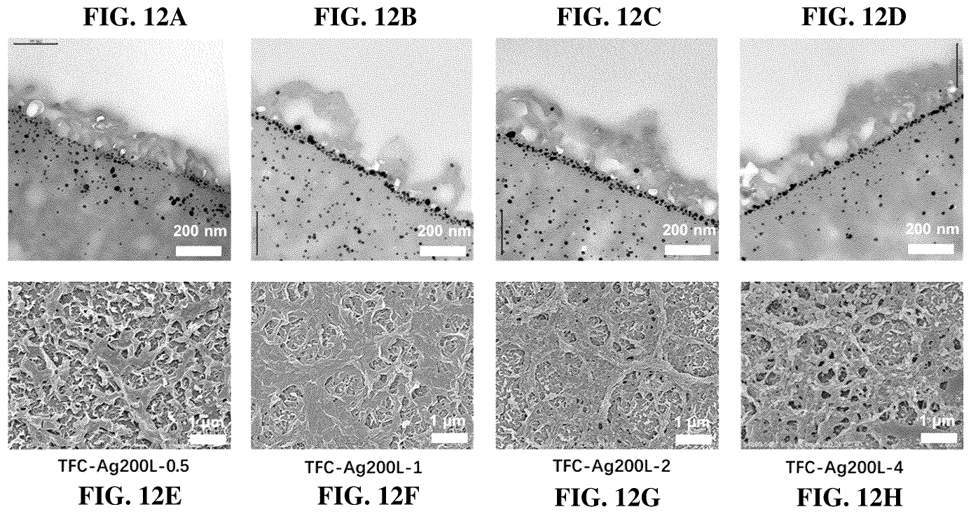

Properties of polyamide membranes under different light intensities (kW/m²) are shown. FIGS. 12A-12D depict TEM micrographs of the membrane cross-sections. FIGS. 12E-12H depict different SEM micrographs of the membrane top surfaces.

FIGS. 6-12 demonstrate the effects of interfacial plasmonic heating on the properties and separation performance of the polyamide membranes according to the present invention.

Increased AgNP loading leads to more prominent polyamide nanovoids (FIGS. 6A-6D), larger leaf-like structures (FIG. 6E-6H), increased polyamide void fractions (FIG. 7A) and high cross-linking degrees (FIG. 7B). The negative charge of the membranes was also enhanced, possibly due to the negatively charged AgNPs. These improved properties resulted in simultaneously enhanced water permeance and NaCl rejection (FIG. 7D).

Further experiments with and without AgNPs and with and without light should confirm that the improved membrane properties (FIGS. 8A-8H) and separation performance (FIG. 9) can be attributed to interfacial plasmonic heating induced by AgNPs.

In addition, experiments under different light wavelengths (e.g., no light, visible light, ˜400 nm, and ˜600 nm) can also confirm the interfacial plasmonic heating effect since 400 nm light illumination resulted in improved membrane properties (FIGS. 10A-10H) and separation performance (FIG. 11) comparable to those of visible light illumination. However, no light or ˜600 nm light illumination showed negligible effects, which can be ascribed to the fact that plasmonic response by AgNPs occurs at the wavelength of ˜400 nm.

Based on the above interfacial plasmonic heating induced by AgNPs, further attempts were made to control the interfacial temperature to tailor membrane properties and separation performance under different light intensities: higher light intensities contributed to larger polyamide nanovoids (FIGS. 12A-12H) and better separation performance (FIG. 7E). These outstanding separation performances largely break the permeance-selectivity trade-off (FIG. 7F).

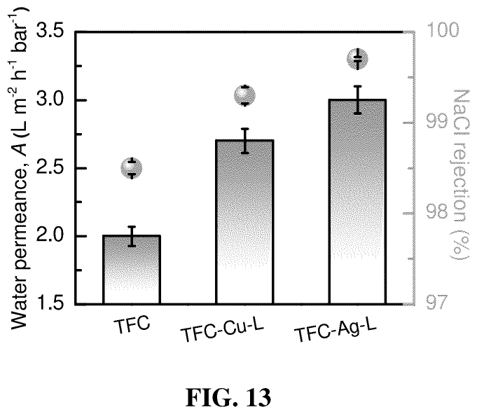

In addition, the interfacial plasmonic heating effect can also be achieved with other nanomaterials (e.g., Cu). The corresponding polyamide membrane shows simultaneously enhanced water permeance and salt rejection (FIG. 13), indicating that a broad choice of photothermal materials can be selected for the plasmonic heating effect.

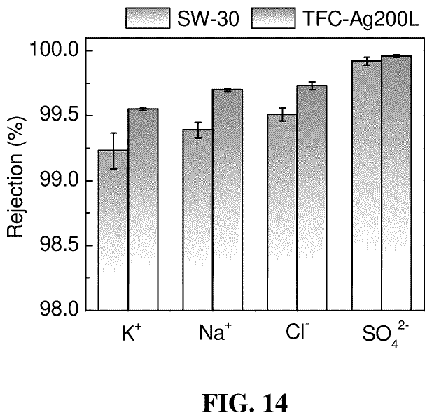

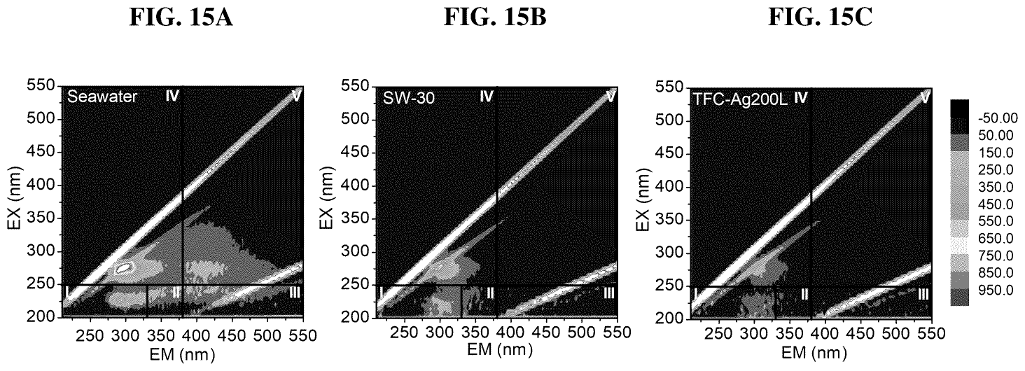

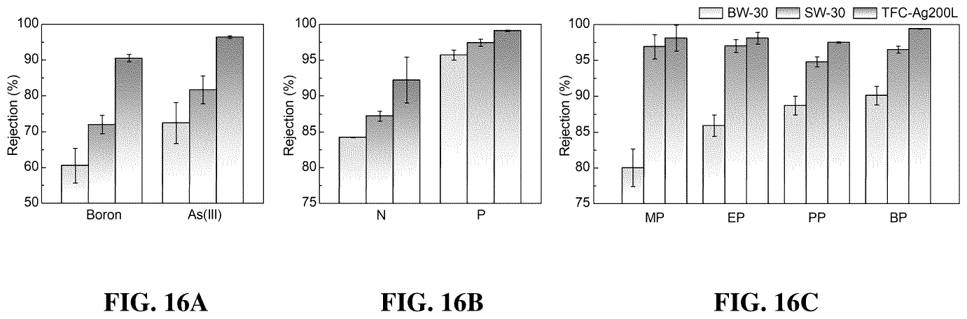

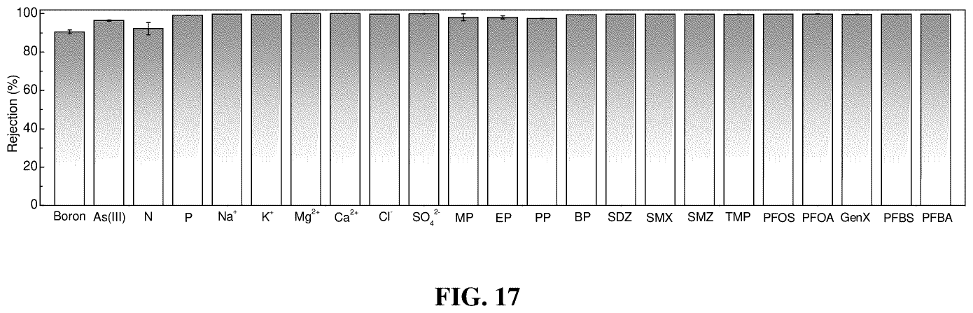

The present invention has applications for versatile water purification. FIGS. 14-17 demonstrate applications for real seawater desalination and contaminant removal according to the present invention. Regarding real seawater desalination, FIG. 14 correspond to plots of real seawater concentrations of Na⁺, K⁺, Cl⁻, and SO₄²⁻, and their rejections by the membranes, which is indicative of desalination. Also, regarding real seawater desalination, FIGS. 15A-15C correspond to the relative temperature intensity in 3D-fluorescence spectra of the dissolved organics in real seawater and permeates of the membranes. FIGS. 16A-16C correspond to plots of removal of specific contaminants. FIG. 16A is a plot of the rejection of B (5 ppm, pH of ˜8.5 for seawater) and As (III) (5 ppm, pH of ˜8.5 for groundwater). FIG. 16B is a plot of the rejection of N (15 ppm, pH of ˜7.5 for wastewater) and P (1 ppm, pH of ˜7.5 for wastewater). FIG. 16C is a plot of the rejection of various EDCs (200 ppb, pH of ˜7.5 for wastewater). FIG. 17 is a plot of the rejection of 17 harmful contaminants frequently found in different water sources (e.g., boron in seawater, As (III) in groundwater, N, P, EDCs, antibiotics, and PFASs in wastewater) and rejection of 6 typical ions by the TFC-Ag200L. Error bars represent standard deviations using three distinct samples.

Regarding real seawater desalination, the TFC-Ag200L membrane shows great advantages desalinating real seawater (removing inorganic salts and organic matter) over the benchmarking commercial membranes (FIG. 14 and FIGS. 15A-15C, respectively).

Regarding removal of contaminants, the TFC-Ag200L membrane showed much higher removal efficiency of a wide variety of contaminants that occur in different water sources (e.g., B in seawater, As (III) in groundwater, and N, P and EDCs in wastewater) than the benchmarking commercial membranes (FIGS. 16A-16C). The above results demonstrate the superiority of IPH-IP RO membranes in achieving highly effective and wide spectrum removal of various harmful and toxic contaminants frequently found in different water sources (FIG. 17), revealing huge potential for versatile water purification applications (e.g., seawater desalination, groundwater treatment, wastewater treatment, and water reuse).

The above are only specific implementations of the invention and are not intended to limit the scope of protection of the invention. Any modifications or substitutes apparent to those skilled in the art shall fall within the scope of protection of the invention. Therefore, the protected scope of the invention shall be subject to the scope of protection of the claims.

### REFERENCES

The cited references in this application are incorporated herein by reference in their entirety and are as follows:
[1] Eliasson, J., The rising pressure of global water shortages. Nature 2015, 517, (7532), 6.
[2] Mekonnen, M. M.; Hoekstra, A. Y., Four billion people facing severe water scarcity. Sci Adv 2016, 2, (2), e1500323.
[3] Culp, T. E.; Khara, B.; Brickey, K. P.; Geitner, M.; Zimudzi, T. J.; Wilbur, J. D.; Jons, S. D.; Roy, A.; Paul, M.; Ganapathysubramanian, B.; Zydney, A. L.; Kumar, M.; Gomez, E. D., Nanoscale control of internal inhomogeneity enhances water transport in desalination membranes. Science 2021, 371, (6524), 72-75.
[4] Caldera, U.; Breyer, C., Learning Curve for Seawater Reverse Osmosis Desalination Plants: Capital Cost Trend of the Past, Present, and Future. Water Resour. Res. 2017, 53, (12), 10523-10538.
[5] Shannon, M. A.; Bohn, P. W.; Elimelech, M.; Georgiadis, J. G.; Marinas, B. J.; Mayes, A. M., Science and technology for water purification in the coming decades. Nature 2008, 452, (7185), 301-10.
[6] Grant, S. B.; Saphores, J. D.; Feldman, D. L.; Hamilton, A. J.; Fletcher, T. D.; Cook, P. L.; Stewardson, M.; Sanders, B. F.; Levin, L. A.; Ambrose, R. F.; Deletic, A.; Brown, R.; Jiang, S. C.; Rosso, D.; Cooper, W. J.; Marusic, I., Taking the “waste” out of “wastewater” for human water security and ecosystem sustainability. Science 2012, 337, (6095), 681-6.
[7] Qasim, M.; Badrelzaman, M.; Darwish, N. N.; Darwish, N. A.; Hilal, N., Reverse osmosis desalination: A state-of-the-art review. Desalination 2019, 459, 59-104.
[8] Tang, C. Y.; Yang, Z.; Guo, H.; Wen, J. J.; Nghiem, L. D.; Cornelissen, E., Potable Water Reuse through Advanced Membrane Technology. Environ. Sci. Technol. 2018, 52, (18), 10215-10223.
[9] Park, H. B.; Kamcev, J.; Robeson, L. M.; Elimelech, M.; Freeman, B. D., Maximizing the right stuff: The trade-off between membrane permeability and selectivity. Science 2017, 356, (6343), eaab0530.
[10] Werber, J. R.; Deshmukh, A.; Elimelech, M., The Critical Need for Increased Selectivity, Not Increased Water Permeability, for Desalination Membranes. Environ. Sci. Technol. Lett. 2016, 3, (4), 112-120.
[11] Yang, Z.; Guo, H.; Tang, C. Y. Y., The upper bound of thin-film composite (TFC) polyamide membranes for desalination. J. Membr. Sci. 2019, 590, 117297.
[12] Bernstein, R.; Belfer, S.; Freger, V., Toward Improved Boron Removal in RO by Membrane Modification: Feasibility and Challenges. Environ. Sci. Technol. 2011, 45, (8), 3613-3620.
[13] Hyung, H.; Kim, J.-H., A mechanistic study on boron rejection by sea water reverse osmosis membranes. J. Membr. Sci. 2006, 286, (1-2), 269-278.
[14] [14] Lim, Y. J.; Goh, K.; Kurihara, M.; Wang, R., Seawater desalination by reverse osmosis: Current development and future challenges in membrane fabrication-A review. J. Membr. Sci. 2021, 629.
[15] Shih, M.-C., An overview of arsenic removal by pressure-drivenmembrane processes. Desalination 2005, 172, (1), 85-97.
[16] [16] Akin, I.; Arslan, G.; Tor, A.; Cengeloglu, Y.; Ersoz, M., Removal of arsenate [As (V)] and arsenite [As (III)] from water by SWHR and BW-30 reverse osmosis. Desalination 2011, 281, 88-92.
[17] Chen, A. S. C.; Wang, L.; Sorg, T. J.; Lytle, D. A., Removing arsenic and co-occurring contaminants from drinking water by full-scale ion exchange and point-of-use/point-of-entry reverse osmosis systems. Water Res. 2020, 172, 115455.
[18] Kimura, K.; Toshima, S.; Amy, G.; Watanabe, Y., Rejection of neutral endocrine disrupting compounds (EDCs) and pharmaceutical active compounds (PhACs) by RO membranes. J. Membr. Sci. 2004, 245, (1-2), 71-78.
[19] [19] Nghiem, L. D.; Manis, A.; Soldenhoff, K.; Schäfer, A. I., Estrogenic hormone removal from wastewater using NF/RO membranes. J. Membr. Sci. 2004, 242, (1-2), 37-45.
[20] Guo, H.; Dai, R.; Xie, M.; Peng, L. E.; Yao, Z.; Yang, Z.; Nghiem, L. D.; Snyder, S. A.; Wang, Z.; Tang, C. Y., Tweak in Puzzle: Tailoring Membrane Chemistry and Structure toward Targeted Removal of Organic Micropollutants for Water Reuse. Environ. Sci. Technol. Lett. 2022, 9, (4), 247-257.
[21] Lu, X.; Elimelech, M., Fabrication of desalination membranes by interfacial polymerization: history, current efforts, and future directions. Chem. Soc. Rev. 2021, 50, (11), 6290-6307.
[22] Freger, V.; Ramon, G. Z., Polyamide desalination membranes: Formation, structure, and properties. Prog. Polym. Sci. 2021, 122, 101451.
[23] Ma, X.-H.; Yao, Z.-K.; Yang, Z.; Guo, H.; Xu, Z.-L.; Tang, C. Y.; Elimelech, M., Nanofoaming of Polyamide Desalination Membranes To Tune Permeability and Selectivity. Environ. Sci. Technol. Lett. 2018, 5, (2), 123-130.
[24] Ma, X.; Yang, Z.; Yao, Z.; Guo, H.; Xu, Z.; Tang, C. Y., Tuning roughness features of thin film composite polyamide membranes for simultaneously enhanced permeability, selectivity and anti-fouling performance. J. Colloid Interface Sci. 2019, 540, 382-388.
[25] Peng, L. E.; Yao, Z.; Liu, X.; Deng, B.; Guo, H.; Tang, C. Y., Tailoring Polyamide Rejection Layer with Aqueous Carbonate Chemistry for Enhanced Membrane Separation: Mechanistic Insights, Chemistry-Structure-Property Relationship, and Environmental Implications. Environ. Sci. Technol. 2019, 53, (16), 9764-9770.
[26] Peng, L. E.; Jiang, Y.; Wen, L.; Guo, H.; Yang, Z.; Tang, C. Y., Does interfacial vaporization of organic solvent affect the structure and separation properties of polyamide RO membranes? J. Membr. Sci. 2021, 625, 119173.
[27] Gan, Q.; Peng, L. E.; Guo, H.; Yang, Z.; Tang, C. Y., Cosolvent-Assisted Interfacial Polymerization toward Regulating the Morphology and Performance of Polyamide Reverse Osmosis Membranes: Increased m-Phenylenediamine Solubility or Enhanced Interfacial Vaporization? Environ. Sci. Technol. 2022, 56, (14), 10308-10316.
[28] Di Vincenzo, M.; Tiraferri, A.; Musteata, V. E.; Chisca, S.; Sougrat, R.; Huang, L. B.; Nunes, S. P.; Barboiu, M., Biomimetic artificial water channel membranes for enhanced desalination. Nat Nanotechnol 2021, 16, (2), 190-196.
[29] Lin, L.; Lopez, R.; Ramon, G. Z.; Coronell, O., Investigating the void structure of the polyamide active layers of thin-film composite membranes. J. Membr. Sci. 2016, 497, 365-376.
[30] Wong, M. C. Y.; Lin, L.; Coronell, O.; Hoek, E. M. V.; Ramon, G. Z., Impact of liquid-filled voids within the active layer on transport through thin-film composite membranes. J. Membr. Sci. 2016, 500, 124-135.
[31] Ghosh, A. K.; Jeong, B.-H.; Huang, X.; Hoek, E. M. V., Impacts of reaction and curing conditions on polyamide composite reverse osmosis membrane properties. J. Membr. Sci. 2008, 311, (1-2), 34-45.
[32] Wen, Y.; Dai, R.; Li, X.; Zhang, X.; Cao, X.; Wu, Z.; Lin, S.; Tang, C. Y.; Wang, Z., Metal-organic framework enables ultraselective polyamide membrane for desalination and water reuse. Sci Adv 2022, 8, (10), eabm4149.
[33] Jauffred, L.; Samadi, A.; Klingberg, H.; Bendix, P. M.; Oddershede, L. B., Plasmonic Heating of Nanostructures. Chem. Rev. 2019, 119, (13), 8087-8130.
[34] [34] Elias, R. C.; Linic, S., Elucidating the Roles of Local and Nonlocal Rate Enhancement Mechanisms in Plasmonic Catalysis. J. Am. Chem. Soc. 2022, 144, (43), 19990-19998.
[35] Naldoni, A.; Shalaev, V. M.; Brongersma, M. L., Applying plasmonics to a sustainable future. Science 2017, 356, (6341), 908-909.
[36] Schuller, J. A.; Barnard, E. S.; Cai, W.; Jun, Y. C.; White, J. S.; Brongersma, M. L., Plasmonics for extreme light concentration and manipulation. Nat Mater 2010, 9, (3), 193-204.
[37] Zhou, L.; Tan, Y.; Ji, D.; Zhu, B.; Zhang, P.; Xu, J.; Gan, Q.; Yu, Z.; Zhu, J., Self-assembly of highly efficient, broadband plasmonic absorbers for solar steam generation. Sci Adv 2016, 2, (4), e1501227.
[38] Zhan, C.; Wang, Q. X.; Yi, J.; Chen, L.; Wu, D. Y.; Wang, Y.; Xie, Z. X.; Moskovits, M.; Tian, Z. Q., Plasmonic nanoreactors regulating selective oxidation by energetic electrons and nanoconfined thermal fields. Sci Adv 2021, 7, (10).
[39] Hirsch, L. R.; Stafford, R. J.; Bankson, J. A.; Sershen, S. R.; Rivera, B.; Price, R. E.; Hazle, J. D.; Halas, N. J.; West, J. L., Nanoshell-mediated near-infrared thermal therapy of tumors under magnetic resonance guidance. Proc Natl Acad Sci USA 2003, 100, (23), 13549-54.
[40] Huschka, R.; Zuloaga, J.; Knight, M. W.; Brown, L. V.; Nordlander, P.; Halas, N. J., Light-induced release of DNA from gold nanoparticles: nanoshells and nanorods. J. Am. Chem. Soc. 2011, 133, (31), 12247-55.
[41] Ben-Sasson, M.; Lu, X.; Bar-Zeev, E.; Zodrow, K. R.; Nejati, S.; Qi, G.; Giannelis, E. P.; Elimelech, M., In situ formation of silver nanoparticles on thin-film composite reverse osmosis membranes for biofouling mitigation. Water Res. 2014, 62, 260-70.
[42] Yang, Z.; Guo, H.; Yao, Z. K.; Mei, Y.; Tang, C. Y., Hydrophilic Silver Nanoparticles Induce Selective Nanochannels in Thin Film Nanocomposite Polyamide Membranes. Environ. Sci. Technol. 2019, 53, (9), 5301-5308.
[43] Song, X.; Gan, B.; Yang, Z.; Tang, C. Y.; Gao, C., Confined nanobubbles shape the surface roughness structures of thin film composite polyamide desalination membranes. J. Membr. Sci. 2019, 582, 342-349.
[44] Song, X.; Gan, B.; Qi, S.; Guo, H.; Tang, C. Y.; Zhou, Y.; Gao, C., Intrinsic Nanoscale Structure of Thin Film Composite Polyamide Membranes: Connectivity, Defects, and Structure-Property Correlation. Environ. Sci. Technol. 2020, 54, (6), 3559-3569.
[45] Gan, Q.; Wu, C.; Long, L.; Peng, L. E.; Yang, Z.; Guo, H.; Tang, C. Y., Does Surface Roughness Necessarily Increase the Fouling Propensity of Polyamide Reverse Osmosis Membranes by Humic Acid? Environ. Sci. Technol. 2023, 57, (6), 2548-2556.
[46] Liu, Y.; Liu, C. H.; Debnath, T.; Wang, Y.; Pohl, D.; Besteiro, L. V.; Meira, D. M.; Huang, S.; Yang, F.; Rellinghaus, B.; Chaker, M.; Perepichka, D. F.; Ma, D., Silver nanoparticle enhanced metal-organic matrix with interface-engineering for efficient photocatalytic hydrogen evolution. Nat Commun 2023, 14, (1), 541.
[47] Shao, P.; Chang, Z.; Li, M.; Lu, X.; Jiang, W.; Zhang, K.; Luo, X.; Yang, L., Mixed-valence molybdenum oxide as a recyclable sorbent for silver removal and recovery from wastewater. Nat Commun 2023, 14, (1), 1365.
[48] Bastus, N. G.; Piella, J.; Puntes, V., Quantifying the Sensitivity of Multipolar (Dipolar, Quadrupolar, and Octapolar) Surface Plasmon Resonances in Silver Nanoparticles: The Effect of Size, Composition, and Surface Coating. Langmuir 2016, 32, (1), 290-300.
[49] Christopher, P.; Xin, H.; Linic, S., Visible-light-enhanced catalytic oxidation reactions on plasmonic silver nanostructures. Nat Chem 2011, 3, (6), 467-72.

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

1. A reverse osmosis (RO) membrane comprising:
m-phenylenediamine (MPD), trimesoyl chloride (TMC), and n-hexane;
a polysulfone (PSf) substrate; and
silver nanoparticles (AgNPs).

2. The RO membrane of claim 1, wherein the MPD, TMC, and n-hexane are applied to prepare polyamide layers on the PSf substrate.

3. The RO membrane of claim 2, wherein the polyamide layers on the PSf substrate are prepared through interfacial polymerization (IP) reactions.

4. The RO membrane of claim 1, wherein the inorganic compounds of silver nitrate (AgNO₃) and sodium borohydride (NaBH₄) are used to generate the AgNPs.

5. The RO membrane of claim 4, wherein the AgNPs are generated in situ on the substrates.

6. A method for fabricating a reverse osmosis (RO) membrane comprising the steps of:
generating silver nanoparticles (AgNPs) in situ on a PSf substrate;
soaking the PSf substrate in a silver nitrate (AgNO₃) solution;
pouring a sodium borohydride (NaBH₄) solution onto the PSf substrate;
rinsing the substrate with deionized (DI) water, resulting in a AgNPs-modified substrate; and
preparing a polyamide layer on the AgNPs-modified substrate.

7. The method of claim 6, wherein the step of soaking also includes shaking for about 10 minutes.

8. The method of claim 7, wherein the shaking occurs at about 50 rpm.

9. The method of claim 6, wherein any extra AgNO₃ solution is removed.

10. The method of claim 9, wherein the removal of any extra AgNO₃ solution is performed with a rubber roller.

11. The method of claim 6, wherein the AgNO₃ solution has a molar mass (mM) concentration within the range of about 50 to 400 mM.

12. The method of claim 6, wherein the NaBH₄ solution has a mM concentration of about 200 mM.

13. The method of claim 6, wherein the step of pouring results in the reduction of one or more silver ions (Ag⁺) to one or more AgNPs.

14. The method of claim 6, wherein the step of pouring also includes shaking for 10 about minutes.

15. The method of claim 14, wherein the shaking occurs at about 50 rpm.

16. The method of claim 6, wherein the step of rinsing occurs for about 5 minutes.

17. The method of claim 6, wherein the step of preparing a polyamide layer on the AgNPs-modified substrate is performed through interfacial polymerization (IP) reactions.

18. The method of claim 17, wherein the IP reactions are catalyzed by simulated solar light illumination.

19. The method of claim 18, wherein the simulated solar light illumination has an intensity of about 1 kW/m².

20. The method of claim 18, wherein the simulated solar light illumination is performed with a xenon lamp.

21. The method of claim 18, wherein the simulated solar light illumination is performed with an Air Mass 1.5 filter.

22. The method of claim 6, wherein the RO membranes are prepared under light wavelengths of approximately 400 nm or 600 nm.

23. The method of claim 6, wherein the RO membranes are prepared under a light wavelength controlled by a band-pass filter.

24. The method of claim 17, wherein the RO membranes are prepared under light intensities ranging between about 0.5 kW/m² to 4 kW/m².

25. The method of claim 18, wherein the RO membranes are prepared with different plasmonic nanomaterials (e.g., Cu and Ag).
